(19) United States
(12) Patent Application Publication
(10) Pub. No.: US 2007/0177213 A1
(43) Pub. Date: Aug. 2, 2007

(54) System and method for controlling clustered halftone dot gain

(76) Inventor: Stephen Herron, Ladera Ranch, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/346,463

(22) Filed: Feb. 2, 2006

(51) Int. Cl. G06K 15/00

(52) U.S. Cl. 358/3.06; 358/3.12

(57) ABSTRACT

A system for characterizing dot gain in pixel-based document rendering devices, such as a printer, receives information relative to current dot size characteristics of the device relative to various tonal levels. This information is compared to stored information to determine a change in dot size. This comparison information is used in conjunction with data representative of cluster dot radius information and dot perimeter information to allow for generation of feedback to linearize output of the document rendering device.

### BACKGROUND OF THE INVENTION

The subject invention is directly generally to control of output quality for document rendering devices, and more particularly to control of devices, such as laser or ink jet printers, which the output of which varies over time. It will be appreciated that the subject invention is applicable to any pixel-based rendering device which outputs a halftone image.

Current document rendering devices, such as ink jet printers, laser printers, facsimile machines, and the like, generate images by application of small dots to a medium. While such rendering is typically associated with hard copy documents, such as print to paper, it will be appreciated that displays, such as video display terminals, LCD displays, CRT displays, and the like, all generate or render images by the use of discrete pixels or dots.

Many pixel based rendering devices will find that their dot or pixel size will vary over time or usage. Since images, such as characters or pictorial images, are rendered by a combination of dots, variation in dot size will result in loss of image quality. Such loss of quality is particularly noticeable in images that are formed from halftoning.

Halftoning is a process by which gray scale images may be generated on a device that may, for example, only produce black dots on a white background. In a halftoning system, a small area or array of dots is treated as a large picture element (“halftone cell”). While this area is substantially larger than that of a dot, selectively turning on various dots or patterns of dots in this area allows it to be perceived, from a distance, as having a shade of gray associated with such a dot arrangement. These “dithered” areas are constructed so as to be placed to allow for visual perception of gray levels to be associated with each such area. Thus, halftoning allows for a trade off between resolution and gray scale. This allows for generation of fairly accurate, black-and-white images from a monotone document rendering device, such as a common laser printer.

Variations in dot size, coupled with generation of halftone images result in unique problems in image degradation attributed to a combination of factors. Relative position of dots in halftones, as well as halftone generation schemes, will affect images differently depending on dot growth. While earlier systems may seek to address measurement of and response to variations in dot size, such systems fail to adequately address additional problems which result in the dot patterns as they are placed in halftone image renderings. Accordingly, there is a need for a system for accurately accessing and addressing variations in dot size from a document rendering device, particularly as it relates to image generation in a halftoning environment.

### SUMMARY OF THE INVENTION

In accordance with the present invention, there is provided a system and method for accurately accessing and addressing variations in dot size from a document rendering device, particularly as it relates to image generation in a halftoning environment.

Further, in accordance with the present invention, there is provided a system for monitoring and adjusting document output characteristics of a pixel-based document rendering device includes a means adapted for receiving dot density data representative of a change in dot density associated with a plurality of tonal levels on a associated document rendering device. The system further includes means adapted for receiving cluster density data representative of a change in cluster dot radius levels associated with a plurality of tonal levels on the document rendering device. The system further includes means adapted for receiving dot perimeter density data which is representative of a change in dot perimeter associated with a plurality of tonal levels on the document rendering device. The dot density data, clustered density data and dot perimeter density data are used for calculation of change in image characteristics on the document rendering device. This calculation result is suitably communicated to a document rendering device to facilitate control thereof.

Still further in accordance with the present invention, there is provided a method for monitoring and adjusting document output characteristics of a pixel-based document rendering device. The method includes the step of receiving dot density data representative of a change in dot density associated with a plurality of tonal levels on a associated document rendering device. The method further includes the step of for receiving cluster density data representative of a change in cluster dot radius levels associated with a plurality of tonal levels on the document rendering device. The method also includes the step of receiving dot perimeter density data which is representative of a change in dot perimeter associated with a plurality of tonal levels on the document rendering device. The dot density data, clustered density data and dot perimeter density data are used for calculation of change in image characteristics on the document rendering device. This calculation result is suitably communicated to a document rendering device to facilitate control thereof.

An advantage of the present invention is the provision of a system by which changes in dot density and a document rendering device may be monitored for change.

Yet another advantage of the present invention is a provision of a system for monitoring change in dot characteristics as they relate to generation of halftone images.

Yet a further advantage of the present invention is the provision of a system which allows for feedback of calculated differences in dot size for halftone images to allow for linearization of an associated document rendering device.

Further advantages will be apparent to one of ordinary skill in the art upon reading and understanding of the subject specification.

### BRIEF DESCRIPTION OF THE DRAWINGS

The subject invention is illustrated in the attached drawings which are for the purposes of illustrating the subject invention and preferred embodiment, and not for the purpose of limiting the same, wherein:

FIG. 1 is a block diagram illustrating the subject system employed in a document rendering device;

FIG. 2 is a block diagram illustrating the monitoring and control for dot density calculation and adjustment in connection with the subject invention;

FIG. 3 is a flow chart of the dot measurement and correction data generation system of the present invention;

FIG. 4 illustrates dot growth and resultant effect on halftone cells;

FIG. 5 illustrates dot perimeter movement curves in connection with a representative printer output; and

FIG. 6 is a graph illustrating linear growth as a function of dot radius in connection with representative measurements of the subject invention.

### DETAILED DESCRIPTION OF THE PREFERRED EMBODIMENT

The subject system is a process which serves to facilitate adjustment of data of a contone image. The system is ideal to function to linearize a dot rendering device so that tonal values of an original image are reproduced accurately on a printer using a halftone screen.

In the subject system, several properties associated with pixel-based, halftone rendering are drawn upon and used. Printer density is measured to include mechanical dot areas as a ratio to actual dot area, media, such as toner, dye, pigment, ink and chemistry; resolution of a halftone screen; and changes in halftone pattern density. Density is defined as an increase of a printer's mechanical dot area change which is influenced by a halftone screen. A mechanical density profile associated with a printer will change with time and environment. While a halftone relationship to density is stable, separation of a dot screen from a mechanical density gain will advantageously result in a production of accurate tone transfer curves with fewer device density measurements. Insofar as a halftones density effects do not change, mechanical density data is suitably sufficient to be gathered when a state of a printer changes. Printer state changes are induced by changes in environment, type of media, energy fluctuations and the like.

The system and method for the present invention uses a change in the radius of a halftone dot caused by three principle dot determiners:

1. Mechanical printer characteristics
a. Diameter of energy (heat, photons, magnetism, chemical)
b. Amount of media (toner, dye, pigment, ink or emulsion)
c. Substrate absorption (coating, rag, texture)

2. Halftone resolution (area of halftone dot)

3. Halftone dot pattern (shape of cluster, distribution of dots, dot arrangements)

Data describing each of the three determiners can be collected and the three data sets combined into one set of data that linearize a printer. Determiners 2 and 3 are stable and need not be changed, wherein determiner 1 changes frequently. Determiners 2 and 3 change the determiner 1's density curve. Thus, the system teaches using the data from measuring the mechanical density profile and combining it with data from determiners 1 and 2 to quickly and accurately derive linearization data.

A typical printer has fast scan in the X-axis direction and slow scan in the Y-axis, directions. In a typical printer a page is suitably described in a grid with coordinates at the device resolution. An exposure is made when the X and Y coordinates of the substrate and print engine are stationary. The number of X and Y coordinates per inch is the device resolution. Resolution is a measure of length between the coordinates. An exposure is an amount of energy that results in a localized difference between the area where a halftone dot lies and the surrounding area. That energy is suitably heat, polarization, chemical, and the like. Energy diameter is usually different the resolution of the page grid.

A difference between tonal value of a contone image and a tonal value of the halftone reproduction of that image is the result of errors in the amount of energy used to create the dot and the amount of media used to produce the dot. The result is a dot with a diameter different than the distance between coordinate intersections or the device resolution.

Three variables contribute errors to achieving accurate tone levels when reproducing a contone image. From greatest dot radius change to lease dot radius change, primary producers of tonal inaccuracies are:
1. Mechanical dot perimeter movement: The combination of energy and media and the radius of the dot in relationship to the resolution.
2. Halftone resolution dot-gain: The size of the halftone dot
3. Halftone dot gain: The shape and pattern of the halftone.dot.

Properties that do not contribute to dot radius change such as optical dot gain, black point of the media, and white point of the substrate are not printout hereto. While such properties may contribute to reproduction errors, these errors are suitably eliminated before the image data reaches the printer. Of the three contributions to dot gain, mechanical dot perimeter movement is the most significant. An amount of dot gain can vary from no dot when the amount of energy is low to significant dot spread when the energy component is large.

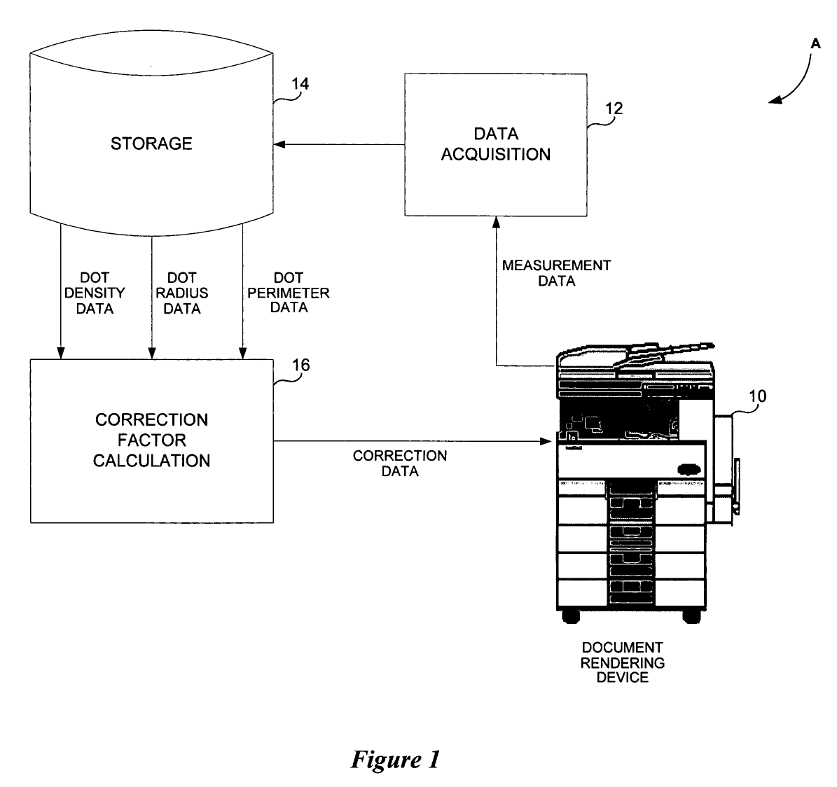

Turning now to FIG. 1, the illustration is a document rendering system A that includes a document rendering device 10, such as a printing device, multifunctional peripheral, facsimile machine, video display terminal, and the like. It will be appreciated that, in the preferred embodiment, dot-printer, such as a laser printer, is addressed. In the illustration, measurement data is obtained from the printer 10 via a data acquisition means 12. As will be detailed below, measurement data includes that associated with dot size associated with the document rendering device. Data thus acquired is communicated to a storage 14. A storage 14 is suitably comprised of random access memory, or alternatively non-volatile memory for more permanent storage. Included in the storage 14 is data representative of dot density, dot radius, and dot perimeter, all of which is communicated to a correction factor calculations means 16, the operation of which will be detailed further below. Correction factor data, once calculated, is communicated back to the document rendering device 10 so as to allow for adjustment thereof.

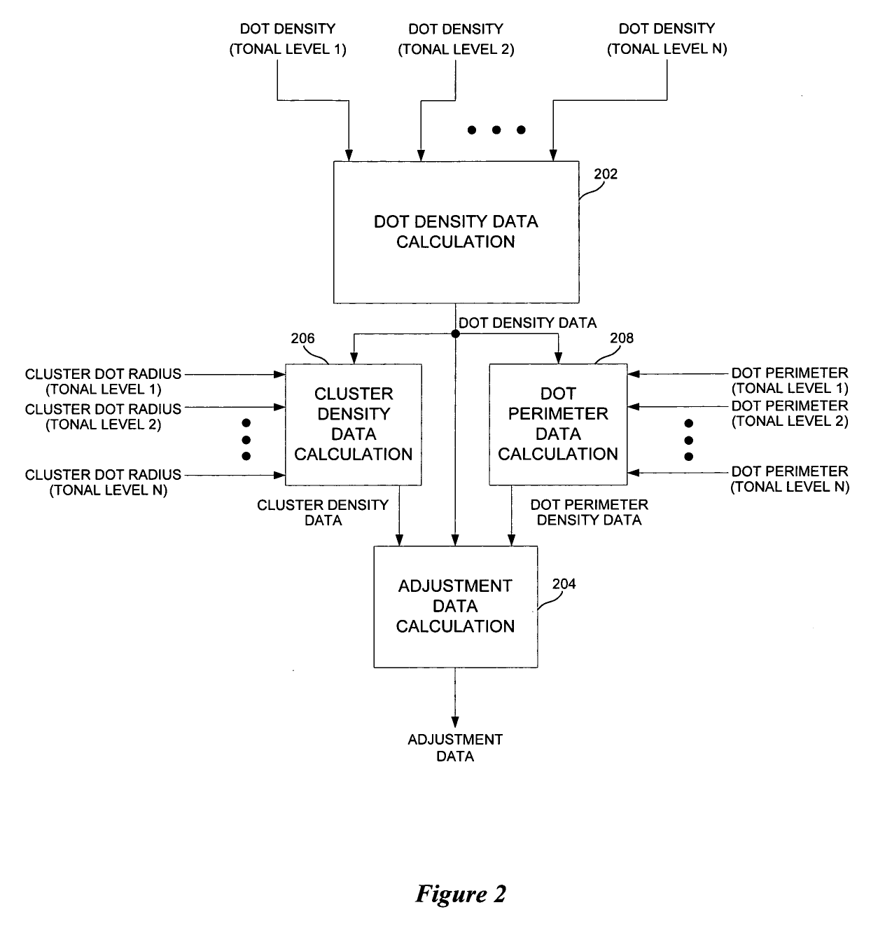

Turning now to FIG. 2, detailed operation of the data acquisition means 12, storage 14 and correction calculation 16 of FIG. 1 will be described. In the illustration, data representative of measured mechanical dot density at various tonal levels is received from a document rendering device into a dot density calculation means 202. In the illustration, a plurality 1, 2, . . . N, of tonal levels is used to acquire dot density information. The dot density information is retrieved and compared against earlier values in the dot density data calculation means 202. A comparison of dot density at various tonal levels, as compared to earlier-obtained values which have been stored in a storage 14 (FIG. 1) allow for difference data between earlier dot density levels to be calculated relative to a current measurement. The resultant dot density data from this calculation is communicated to an adjustment data calculation means 204 which combines this information with two other data values.

Dot density data is also communicated to a cluster density data calculation means 206. Means 206 combines dot density data with cluster-radius data associated with a plurality of tonal levels 1, 2, . . . , N. Ideally, the number of levels N correspond to that associated with a dot density calculation means 202. The cluster dot radius information that is input to the cluster density data calculation means 206 is suitably measured from an associated document rendering device at the various tonal levels. It is to be appreciated, however, that fixed values of cluster dot radius levels at various tonal levels are also suitably utilized for performing calculations. In the cluster density data calculation means 206, cluster density data is calculated from both the dot density data and input cluster dot radius at the various tonal levels by addition thereof. This cluster density data is communicated to the adjustment data calculation means 206 for combination with the dot density data as noted above.

Dot density data from the dot density data calculation means 202 is also communicated to a dot perimeter data calculation means 208. Analogously to the means 206, the dot perimeter calculation means 208 receives dot perimeter information measured at various tonal values from the document rendering device. Similarly, it is to be appreciated that such dot perimeter information at the various tonal levels is also suitably fixed as noted in conjunction with a flowchart of the subject system is described.

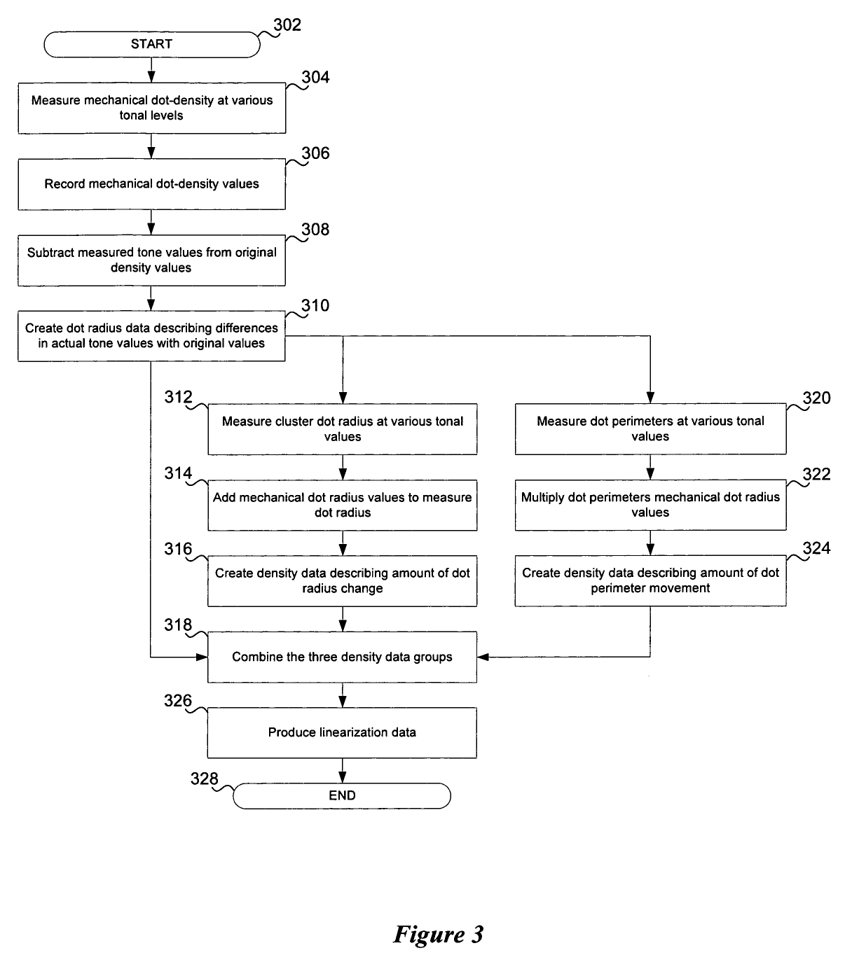

FIG. 3 is a flowchart of the density linearization process described above. First, the operation is commenced at block 302, next, at block 304, a measurement of mechanical dot density at various tonal levels is made at a document rendering device. These values are recorded next at block 306, and stored in a storage, such as storage 14 shown in FIG. 1. Earlier values are compared to more recently measured values at block 308, such as noted in connection with the dot density calculation 202 of FIG. 2. Next, at block 310, a dot radius data describing differences in actual tone value of the original values is completed.

The dot density data thus calculated is communicated to block 312, at which point a measurement of cluster dot radius at various tonal levels is completed. The measured cluster dot radius levels are then added to the values from block 310 at block 314 so as to create density data describing an amount of dot radius change at block 316. Dot density data from block 310 is also communicated to block 320, which receives measure dot perimeters dot perimeters at various tonal values. These values are multiplied with the dot density data from block 310 to block 322 to achieve dot perimeter density data at block 324. These values are further communicated to block 318. Block 318 combines the values thus calculated to produce linearization data at block 326 which allows for feedback to the document rendering device for adjustment thereof. Block 328 illustrates an end of the process.

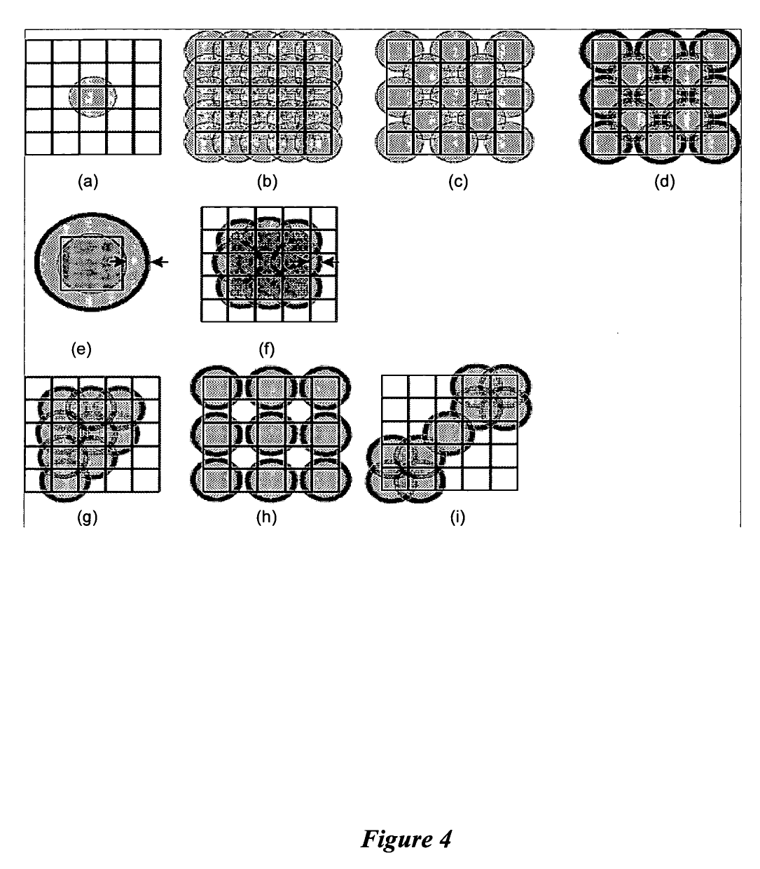

FIG. 4(a) illustrates a device dot placed on a grid of device coordinates. In this case the X and Y coordinates are at the center of each square. The round dot covers an area greater than one square of the grid. FIG. 4(b) illustrates that when each square of the grid is cover with a device dot, then the amount of media deposited on the substrate is greater than needed to cover the substrate and overlapping occurs. FIG. 4(c) demonstrates that eliminating 50% of the dots will still result in almost 100% coverage. FIG. 4(d) adds an increase in dot radius cause by the media and the substrate absorption extending the dot perimeter further. The result now is 100% coverage.

FIG. 4(e) illustrates the maximum change in radius of the device dot. The radius change can be measured and the changes throughout the tonal range collected as data. FIG. 4(f) illustrates that since the increase in the dot's radius is constant the, as a dot increases in area by clustering many dots together the ratio of mechanical dot radius difference to cluster dot radius decreases. Hence the amount of spread decreases as the halftone dot diameter increases. The halftone resolution or dot size can decrease the mechanical density by clustering dots together and increase the mechanical density by making smaller dot clusters.

The halftone pattern also affects the printer device density. FIG. 4(g) through FIG. 4(i) illustrate clusters of nine device-dots in different configurations. FIG. 4(g) is roughly triangular and the perimeter length is greater than the dot cluster of FIG. 4(f) hence a density increase occurs. FIG. 4(h) distributes the dots so that they do not overlap. The total perimeter of all individual dots is longer than any clustered dot and the density is increased. FIG. 4(i) illustrates two clusters of four device-dots joined with a single dot. This dot configuration produces a density gain amount greater than FIG. 4(g) but less than FIG. 4(h). In general, the greater the order of device-dots, the more symmetrical the relationship between the dots, and the more overlap, then the shorter the perimeters and hence the more accurate the density level. A halftone density change is characteristic for each dot pattern of a halftone and the density change is constant.

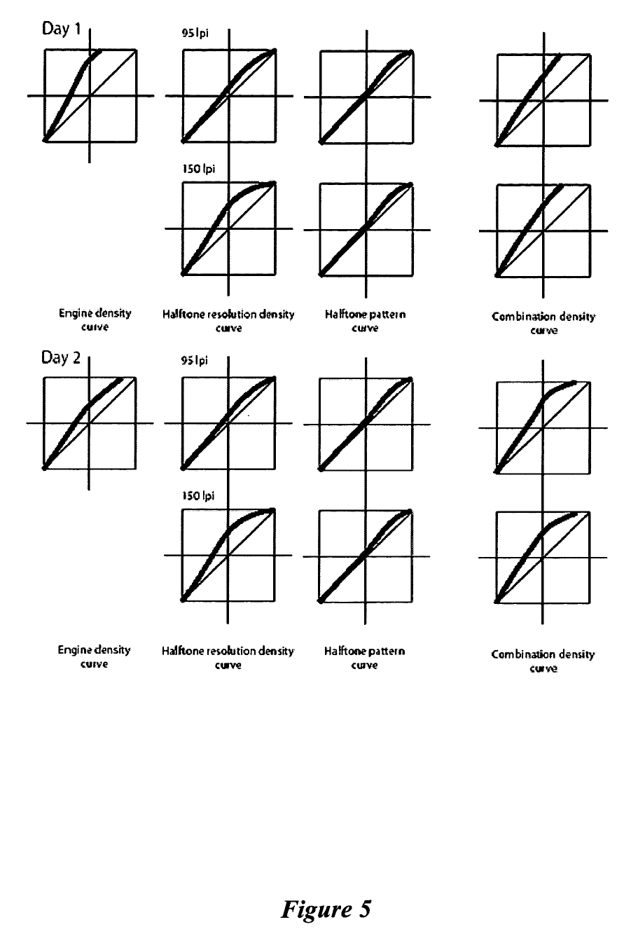

FIG. 5 displays the dot perimeter movement curves of a hypothetical printer. The resolution and halftone profile curves do not change, but the combined curve changes with the change in mechanical dot gain from day one to day two.

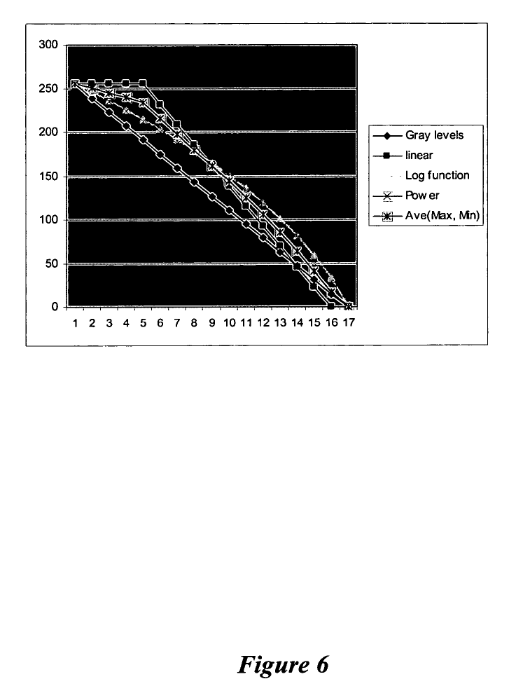

The mechanical dot perimeter movement is variable over time and has the greatest effect on tonal density. The halftone resolution density and halftone pattern density functions can be calculated once. Only the mechanical density need be measured and determined periodically. In Table 1 and FIG. 6, the mechanical density is calculated as a linear-growth function of the dot radius. The actual growth may be charted as a determined by least squares distance of a scatter plot from various measurements and may result in any type of curve. Mechanical dot spread may be the result of any function derived from direct measurements.

In Table 1 and FIG. 6, the halftone resolution density is a Log function. It decreases the dot spread in the shadows and increases the dot spread in the highlights and midtones. A base-10 log function is used in this example. Each type of printer may have a unique reproduction curve.

The halftone density curve in Table 1 and FIG. 6 is a power function. In this example a gamma of 1.4 is used. While most halftone patterns change density in a manner modeled by a power function, any method of characterizing the density change of a halftone pattern may be used.

The combined density curve in Table 1 and FIG. 6, is used to characterize the printer. The function used in this example is a simple average of the minimum values and the maximum values at each tone level. Many other methods for combining curves may be used.

TABLE 1

| | | | Resolution | Halftone | Combined |
|---|---|---|---|---|---|
| 8-bit Levels | 0 to 1 Range | Engine Density | Density | Density | Density |
| Tone Levels | Normalized | Linear | Log Function | Power | Ave)Max.Min) |
| 255 | 1 | 255 | 255 | 255 | 255 |
| 239 | 0.937255 | 255 | 246 | 245 | 250 |
| 223 | 0.87451 | 255 | 236 | 235 | 245 |
| 207 | 0.811765 | 255 | 226 | 224 | 239 |
| 191 | 0.74902 | 255 | 215 | 212 | 233 |
| 175 | 0.686275 | 232 | 204 | 199 | 216 |
| 159 | 0.623529 | 209 | 192 | 186 | 198 |
| 143 | 0.560784 | 185 | 179 | 173 | 179 |
| 127 | 0.498039 | 162 | 165 | 158 | 162 |
| 111 | 0.435294 | 139 | 151 | 142 | 145 |
| 95 | 0.372549 | 116 | 136 | 126 | 126 |
| 79 | 0.309804 | 93 | 119 | 109 | 106 |
| 63 | 0.247059 | 70 | 101 | 90 | 85 |
| 47 | 0.184314 | 46 | 82 | 70 | 64 |
| 31 | 0.121569 | 23 | 59 | 49 | 41 |
| 15 | 0.058824 | 0 | 33 | 25 | 17 |
| 0 | 0 | 0 | 0 | 0 | 0 |

Note that the mechanical density curve does not always produce the largest dot spread. Example, both the halftone resolution curve and the halftone curve increase the density in the highlights and decrease density in the shadows.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions and alterations can be made therein without departing from the spirit and scope of the invention as defined by the appended claims. It will be appreciated that various changes in the details, materials, and arrangement parts, which have been herein described and illustrated in order to explain the nature of the invention, may be made by those skilled in the area within the principle and scope of the invention as will be expressed in the appended claims.

What is claimed is:

1. A system for adjusting document output characteristics of a pixel-based document rendering device comprising:
adjustment data calculation means including,
dot density data receiving means adapted for receiving dot density data representative of a change in dot density associated with a plurality of tonal levels on an associated document rendering device;
cluster density data receiving means adapted for receiving cluster density data representative of a change in cluster dot radius levels associated with a plurality of tonal levels on the associated document rendering device;
dot perimeter data receiving means adapted for receiving dot perimeter density data representative of a change in dot perimeter associated with a plurality of tonal levels on the associated document rendering device; and
adjustment data calculation means adapted for calculating adjustment data in accordance with the dot radius data, the dot density data and the dot perimeter density data; and
means adapted for communicating adjustment data to the associated document rendering device.

2. The system for adjusting document output characteristics of a pixel-based document rendering device of claim 1 wherein:
the dot density data incorporates data associated with measured dot density on the associated document rendering device and stored dot density data retrieved from a first storage location of an associated data storage;
the cluster density data incorporates data representative of stored cluster dot density data retrieved from a second storage location of the associated data storage; and
the dot perimeter density data incorporates data representative of stored dot perimeter data retrieved from a third storage location of the associated data storage.

3. The system for adjusting document output characteristics of a pixel-based document rendering device of claim 2 wherein the dot density data, the cluster density data and the dot perimeter density data are functionally related to a plurality of dot density levels which correspond to a plurality of tonal levels of the associated document rendering device.

4. The system for adjusting document output characteristics of a pixel-based document rendering device of claim 3 further comprising:
cluster density calculation means including,
means adapted for receiving cluster dot radius input data representative of cluster dot radius levels of the associated document rendering device, and
means adapted for calculating the cluster density data from received cluster dot radius input data and received dot density data; and
dot perimeter density calculation means including,
means adapted for receiving dot perimeter input data representative of dot perimeter levels of the associated document rendering device; and
means adapted for calculating the dot perimeter density data from received cluster dot radius input data and the dot density data.

5. The system for adjusting document output characteristics of a pixel-based document rendering device of claim 4 wherein cluster dot radius input data and the dot perimeter input data are fixed in accordance with a property of the associated document rendering device.

6. The system for adjusting document output characteristics of a pixel-based document rendering device of claim 4 wherein the adjustment data calculation means includes means adapted for generating the adjustment data so as to linearize an output of the associated document rendering device.

7. The system for adjusting document output characteristics of a pixel-based document rendering device of claim 6 wherein:
the cluster density calculation means incorporates a summation of cluster dot radius input data and received dot density data to generate the cluster density data; and
the dot perimeter calculation means incorporates a multiplication of dot perimeter input data and dot density data to generate the dot perimeter density data.

8. A method for adjusting document output characteristics of a pixel-based document rendering device comprising the steps of:
receiving dot density data representative of a change in dot density associated with a plurality of tonal levels on an associated document rendering device;
receiving cluster density data representative of a change in cluster dot radius levels associated with a plurality of tonal levels on the associated document rendering device,
receiving dot perimeter density data representative of a change in dot perimeter associated with a plurality of tonal levels on the associated document rendering device, and
calculating adjustment data in accordance with the dot radius data, the dot density data and the dot perimeter density data; and
communicating adjustment data to the associated document rendering device.

9. The method for adjusting document output characteristics of a pixel-based document rendering device of claim 8 wherein:
the dot density data incorporates data associated with measured dot density on the associated document rendering device and stored dot density data retrieved from a first storage location of an associated data storage;
the cluster density data incorporates data representative of stored cluster dot density data retrieved from a second storage location of the associated data storage; and
the dot perimeter density data incorporates data representative of stored dot perimeter data retrieved from a third storage location of the associated data storage.

10. The method for adjusting document output characteristics of a pixel-based document rendering device of claim 9 wherein the dot density data, the cluster density data and the dot perimeter density data are functionally related to a plurality of dot density levels which correspond to a plurality of tonal levels of the associated document rendering device.

11. The method for adjusting document output characteristics of a pixel-based document rendering device of claim 10 further comprising the steps of:
receiving cluster dot radius input data representative of cluster dot radius levels of the associated document rendering device, and
calculating the cluster density data from received cluster dot radius input data and received dot density data;
receiving dot perimeter input data representative of dot perimeter levels of the associated document rendering device, and
calculating the dot perimeter density data from received cluster dot radius input data and the dot density data.

12. The method for adjusting document output characteristics of a pixel-based document rendering device of claim 11 wherein cluster dot radius input data and the dot perimeter input data are fixed in accordance with a property of the associated document rendering device.

13. The method for adjusting document output characteristics of a pixel-based document rendering device of claim 11 further comprising the step of generating the adjustment data so as to linearize an output of the associated document rendering device.

14. The method for adjusting document output characteristics of a pixel-based document rendering device of claim 13 further comprising the steps of:
computing a summation of cluster dot radius input data and received dot density data to generate the cluster density data; and
performing a multiplication of dot perimeter input data and dot density data to generate the dot perimeter density data.
